(19) United States
(12) Patent Application Publication
(10) Pub. No.: US 2007/0253418 A1
(43) Pub. Date: Nov. 1, 2007

(54) ROUTING PATH OPTIMIZATION BETWEEN SIP ENDPOINTS

(75) Inventors: Effi SHIRI, Petah Tikva (IL); Neta ZMORA, Tzur Moshe (IL)

Correspondence Address: BROWDY AND NEIMARK, P.L.L.C.;624 NINTH STREET, NW, SUITE 300, WASHINGTON, DC, 20001-5303, US

(73) Assignee: D.S.P. Group Ltd., Herzliya (IL)

(21) Appl. No.: 11/740,621

(22) Filed: Apr. 26, 2007

Related U.S. Application Data
(60) Provisional application No. 60/795,169, filed on Apr. 27, 2006.

(51) Int. Cl. H04L 12/56

(52) U.S. Cl. 370/392

(57) ABSTRACT

Methods and systems for optimized routing of real time media session data between session initiation protocol SIP endpoints. In one embodiment of the invention, first and second SIP endpoints each provide notification of network address translation NAT topology thereof and based on the NAT topologies of the two endpoints an SIP server decides whether to route media between the two endpoints via a direct path or via a media relay.

### CROSS-REFERENCE TO RELATED APPLICATION

This application claims the benefit of U.S. provisional application 60/795,169 filed on Apr. 27, 2006, which is hereby incorporated by reference herein.

### FIELD OF THE INVENTION

The invention relates to the transportation of real time media session data over a packet switched network, such as for example the Internet.

### BACKGROUND OF THE INVENTION

The transportation over the Internet of real time media session data has become more prevalent. For example, the Real-time Transport Protocol RTP defines a standardized packet format for delivering media session data over the Internet. The Session Initiation Protocol SIP (for example conforming with Request For Comments, RFC 3261) is an application-layer control (signaling) protocol for creating, modifying, and terminating sessions. SIP supports five facets of establishing and terminating media communications: user location determination, user availability determination, user capabilities determination, session setup, and session management. Data sent between SIP elements as part of the Session Initiation Protocol include request messages and response messages. The body of a message sent between SIP elements contains a description of the session encoded in a protocol such as Session Description Protocol SDP (conforming for example to RFC 2327). For example, a transmitting endpoint may include inter-alia in an SDP message the Internet Protocol IP address and port number of the transmitting SIP endpoint. The routing of voice conversations over the Internet is commonly termed Voice Over Internet Protocol VoIP.

A Network Address Translator NATs such as a router or firewall performs a one-to-one or many-to-one JP address translation (mapping). An internal (AKA local, private) IP address of an SIP endpoint is mapped to an external (AKA global, public, assigned, mapped) IP address. In a many-to-one NAT (also called Network Address Port Translation NAPT) many inside addresses are mapped to one outside address. In a one-to-one NAT, each inside address is mapped to a different outside address. Each NAT maintains a correspondence (“bindings”) that links inside IP addresses and port numbers to outside IP addresses and port numbers.

Assuming that a transmitting endpoint includes the private IP address/port number in an SDP message, the presence of a NAT in front of the endpoint may create connectivity problems if routing to the endpoint is attempted using the private IP address/port number included in the SDP message. One solution described in www.newport-networks.com/cust-docs/33-NAT-Traversal.pdf includes the use of an intermediary server which always acts as a transit point for SIP (signaling) messages and media streams between SIP endpoints. However, from a resource (for example time, cost) perspective, an ideal media routing path between two SIP endpoints communicating over the Internet infrastructure traverses the shortest path (cumulative transmission delay) between the endpoints, without any unnecessary intervention of intermediaries.

### SUMMARY OF THE INVENTION

According to the present invention, there is provided a method for optimally routing media between Session Initiation Protocol (SIP) endpoints, comprising: during setup of a session between a first and a second SIP endpoints, retrieving a Network Address Translator (NAT) topology associated with the first SIP endpoint and a NAT topology associated with the second SIP endpoint, wherein an indication of the first associated topology and an indication of the second associated NAT topology had been previously provided by the first and second SIP endpoints respectively; and if a combination of the NAT topology associated with the first endpoint and the NAT topology associated with the second endpoint corresponds to a direct media path, deciding that media will be directly routed between the first and second SIP endpoints during the session.

According to the present invention, there is also provided a method for allowing optimal routing of media between Session Initiation Protocol (SIP) endpoints, comprising: an SIP endpoint determining a Network Address Translator (NAT) topology associated with the endpoint; and the SIP endpoint providing an indication of the NAT topology in order to allow an SIP server during a setup of a subsequent session between the endpoint and another endpoint to decide based on the indicated NAT topology and a NAT topology associated with and indicated by the another endpoint whether to route media between the endpoint and the another endpoint directly or via a media relay.

According to the present invention, there is further provided a system for optimally routing media between Session Initiation Protocol (SIP) endpoints, comprising: a database configured to store associations between Network Address Translator (NAT) topologies and SIP endpoints, based on notifications received from associated endpoints; and an SIP server configured to access stored NA topologies of endpoints participating in a session and to select, based on the accessed NAT topologies, a direct media path or a relayed media path between the participating endpoints.

According to the present invention there is vet further provided an SIP endpoint, comprising: means for determining a Network Address Translator (NAT) topology associated with the endpoint; and means for providing an indication of the NAT topology in order to allow an SIP server during a setup of a subsequent session between the endpoint and another endpoint to decide based on the indicated NAT topology and a NAT topology associated with and indicated by the another endpoint whether to route media between the endpoint and the another endpoint directly or via a media relay.

According to the present invention there is still further provided a network for optimally routing media between Session Initiation Protocol (SIP) endpoints, comprising: at least one Simple Traversal of User Datagram Protocol through NATs (STUN) server; at least two SIP endpoints, each configured to use the at least one STUN server to discover a NAT topology associated with the endpoint; a database configured to store NAT topologies discovered by the at least two endpoints; and an SIP server configured to access stored NAT topologies associated with endpoints participating in a session and to select, based on the accessed NAT topologies, a direct media path or a relayed media path between the participating endpoints.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of a network, according to an embodiment of the present invention;

FIG. 2 is a protocol message exchange diagram for a scenario, according to an embodiment of the present invention;

FIG. 3 is a protocol message exchange diagram for another scenario, according to an embodiment of the present invention;

FIG. 4 is a protocol message exchange diagram for another scenario, according to an embodiment of the present invention; and

FIG. 5 is a protocol message exchange diagram for another scenario, according to an embodiment of the present invention.

### DETAILED DESCRIPTION OF EXEMPLARY EMBODIMENTS

Described herein are embodiments of the current invention for routing path optimization between SIP endpoints.

Unless defined otherwise, all technical terms used herein have the same meaning as commonly understood by one of ordinary skill in the art to which this invention belongs. Generally (although not necessarily), the nomenclature used herein is well known and commonly employed in the art. Unless described otherwise, conventional methods are used, such as those provided in various general references, known protocols, and in the art.

As used herein, the phrase “for example,” “such as” and variants thereof describing exemplary implementations of the present invention are exemplary in nature and not limiting.

Reference in the specification to “one embodiment”, “an embodiment”, “some embodiments”, “another embodiment”, “other embodiments” or variations thereof means that a particular feature, structure or characteristic described in connection with the embodiment(s) is included in at least one embodiment of the invention. Thus the appearance of the phrase “one embodiment”, “an embodiment” “some embodiments”, “another embodiment” “other embodiments” or variations thereof do not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it should be appreciated that throughout the specification discussions, utilizing terms such as, “realizing”, detecting”, “retrieving”, “providing”, “deciding”, “routing”, “associating”, “relaying” “receiving”, “sending”, “processing”, “determining”, “allowing”, “evaluating”, “inserting” “transferring”, “transmitting”, “providing”, “forwarding”, “recognizing” “extracting”, “accessing”, “selecting”, “notifying”, “indicating”, “communicating”, “discovering”, “storing”, “saving”, “computing”, “calculating”, or the like, refer to the action and/or processes of any combination of software, hardware and/or firmware.

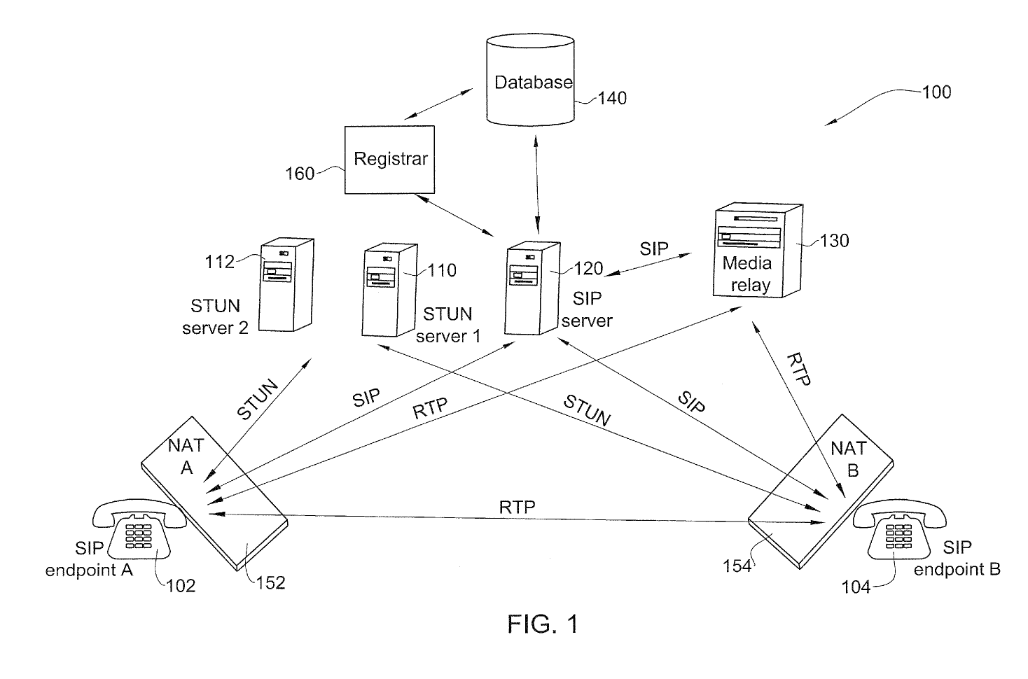

Refer to FIG. 1 which shows a network 100, according to one embodiment of the present invention.

As shown in FIG. 1, network 100 includes an SIP endpoint A 102, an SIP endpoint B 104, Simple Traversal of User Datagram Protocol through NATs STUN servers 110 and 112, an SIP server 120, an SIP Registrar 160, a database 140, and a media relay 130. Each endpoint A 102 or B 104 may have a public IP address or may reside behind a NAT which has a public IP address. In one embodiment, endpoint A 102 is behind a NAT A 152. In one embodiment, endpoint B 104 is behind a NAT B 154. In one embodiment, one or both of endpoints A 102 and B 104 is/are not hidden by a NAT. The single form of NAT (for example when referring to NAT 152, NAT 154) is used herein to include both embodiments where an endpoint is hidden by one NAT and embodiments where an endpoint is hidden by a series of NATs.

Network 100 is comprised in or comprises one or more packet switched networks capable of performing the functions as defined and explained herein. In some embodiments, the public part of network 100 may be a provider network for transporting real time media session data such as for example an Internet Telephony Service Provider ITSP network providing telephony service (i.e. VoIP). In one of these embodiments, if NAT 152 and/or 154 are present, the private part(s) of network 100 (i.e. behind (the innermost) NAT 152 and/or behind (the innermost) NAT 154) may be local area network(s) LAN(s).

During a session in which endpoints A 102 and B 104 participate, signaling (control) streams and real time media session data (i.e. media streams including for example any combination of voice (audio), video, text messages, DTMF tones, etc.) may be transported over network 100 between endpoint A 102 and endpoint B 104, directly or indirectly.

Embodiments of the invention provide methods and/or systems for optimizing the media path used by communicating SIP endpoints A 102 and B 104, so that usage of a media relay 130 is minimized. For example, one embodiment uses a combination of protocols (with the exception of any variations described herein) for endpoints A 102 and B 104 to discover and indicate the NAT type (if any) in front of each communicating endpoint to a central entity (for example to SIP server 120 and/or registrar 160) so that SIP server 120 can determine the best possible route for the media streams sent during a session between endpoints 102 and 104. Because SIP server 120 is aware of the NAT topological status (AKA NAT topology, NAT topological information) of both endpoints 102 and 104 (see below), SIP server 120 can make a optimized decision about how the media streams between endpoint 102 and 104 should be routed. In one embodiment, media is routed directly between communicating endpoints 102 and 104 whenever possible (which in many cases leads to reduced delay and/or cost) and relayed through the media relay 130 only when direct routing is not possible. However, in other embodiments, media streams may in some cases be relayed via media relay 130 even when direct routing is possible in order to satisfy implementation-specific criteria.

In the embodiment illustrated in FIG. 1 the following protocols inter-alia are used for communications in network 100: STUN between endpoint A 102 and STUN server 110) and/or 112; STUN between endpoint B 104 and STUN server 110 and/or 112; SIP for signaling between endpoint 102 and SIP server 120; SIP for signaling between endpoint 104 and SIP server 120; SIP for signaling between SIP server 120 and media relay 130; RTP defining the packet format for delivering the real time media session data between endpoint A 102 and endpoint B 104; RTP for defining the packet format for delivering the real time media session data between media relay 130 and endpoint A 102; RTP for defining the packet format for delivering the real time media session data between media relay 130 and endpoint B 104. In one embodiment, the transport layer protocol(s) used in network 100 include(s) User Datagram Protocol UDP and/or Transmission Control Protocol TCP.

In some embodiments, Simple Traversal of UDP through NATs STUN is used as described in RFC 3489, with the exception of any variations described herein. RFC 3489 is hereby incorporated by reference herein. For example, in one of these embodiments STUN is used to discover the NAT topological status of an endpoint. In another example, in one of these embodiments, STUN is alternatively or additionally used to discover the public IP address and/or port that the NAT has assigned the endpoint for the media streams.

SIP signaling in accordance with some embodiments of the invention follows the procedures described for example in RFC 3261 and/or for example in Extension to the Session Initiation Protocol (SIP) for Symmetric Response Routing, RFC 3581, with the exception of any variations described herein. RFC 3261 and RFC 3581 are hereby incorporated by reference herein. In one of these embodiments, SIP signaling between communicating endpoints 102 and 104 or between any endpoint 10 or 104 and another element of network 100, for both outbound and inbound calls, are routed through the SIP server 120, however in other embodiments some signaling may follow different routes, mutatis mutandis.

In Other embodiments of the invention may use less, more and/or different protocols than illustrated in FIG. 1 for communication in network 100.

Endpoint A 102, endpoint B 104, STUN servers 110 and 112, SIP server 120, media relay 130, (optional) NAT 152 and 154, database 140 and SIP registrar 160 each may include any combination of software, hardware or firmware capable of performing the functions as defined and explained herein.

Endpoint A 102 and endpoint B 104 are peers in network 100. Depending on the embodiment, network 100 may include any number of endpoints. However for simplicity of illustration only two endpoints (namely, endpoint A 102 and endpoint B 104) are illustrated in FIG. 1. For the sake of consistency, it is assumed herein that endpoint A 102 is the initiator (originator, inviter) who initiates the session with endpoint B 104 (invited endpoint). For example, in a VoIP embodiment, endpoint A 102 is assumed to be the caller and endpoint B 104 is assumed to be the called endpoint. In one embodiment, each of endpoint A 102 and endpoint B 104 may comprise or be comprised in any of the following inter-alia: SIP phone, SIP application (softphone), phone plus SIP adaptor, etc.

In one embodiment each of optional NAT A 152 and B 154 may comprise or be comprised in any of the following inter-alia: router, firewall, etc. Depending on the embodiment, NAT A 152 may perform one-to-one address translation or many-to-one address translation. Depending on the embodiment, NAT B 154 may perform one-to-one address translation or many-to-one address translation.

In one embodiment, the functionality of endpoint A 102 and NAT A 152 may be combined together, and/or the functionality of endpoint B 104 and NAT B 154 may be combined together. For ease of understanding, however, endpoints 102 and 104 are differentiated from NATs 152 and 154 respectively in the description herein.

In some embodiments, each of endpoints A 102 and B 104 is configured to discover NAT topology thereof and notify a central entity of the discovered NAT topology. In these embodiments, the form and/or content of notifications and/or the notified central entity may vary depending on the embodiment. For example, in one embodiment, registrar 160 is configured to determine the NAT topological status of endpoints 102 and 104 based on the contents of Register requests sent by endpoints 102 and/or 104 and configured to store NAT topological status in database 140. In another embodiment, additionally or alternatively, SIP server 120 may be configured to determine NAT topological status relating to endpoints 102 and 104 based on the contents of messages/signals sent by endpoints 102 and/or 104 and configured to store NAT topological status in database 140.

In one embodiment, during setup of a session in which endpoints A 102 and B 104 will participate, SIP server 120 is configured to retrieve NAT topologies associated with endpoint A 102 and endpoint B 104, for example by looking up stored NAT topologies in database 140, and configured to decide at least partly based on these retrieved NAT topologies whether to allow media streams to be routed directly between endpoints A 102 and B 104 or via media relay 130.

In one embodiment, database 140 is a central backend database associated with SIP server 120 and/or registrar 160. Depending on the embodiment, database 140 may or may not comprise or be comprised in a location service which provides address mappings (bindings) for a particular domain. In one embodiment, registrar 160 acts as a front end to the location service, reading and writing mappings based on the contents of Register requests from endpoints 102 and 104 and SIP server 120 consults the location service in order to route to the current location.

In one embodiment, SIP server 120 is co-located and/or in communication with SIP registrar 160 and/or database 140.

Media relay 130 is used when SIP server 120 determines that media should be routed via a media-relay as will be explained in more detail below. In one embodiment, media ready 130 has a public IP address.

In one embodiment, media relay 130 and SIP server 120 are both comprised in a Session Border Controller SBC or in a gateway in a public switched telephone network PSTN.

Because media relay 130 performs known functionality in relaying media streams, the functions will not be discussed in great detail herein. For example, if media relay 130 is part of an SBC and the packet format of the media is defined by RTP, then in one embodiment, the SBC may route the RTP streams through its RTP-relay interface as known in the art.

In one embodiment, STUN servers 110 and 12 are elements configured to receive STUN requests and send STUN responses as will be explained in more detail below.

In order to facilitate reader understanding, the functionality of network 100 is divided among the modules shown in FIG. 1 but the division should not be considered binding. In some embodiments of the invention, network 100 may comprise fewer, more, and/or different modules than those shown in FIG. 1. For example, in one of these embodiments, there may be additional STUN server(s), endpoint(s), SIP server(s), media relay(s), registrar(s), NAT(s) and/or database(s). For example, in one of these embodiments, there may be fewer STUN servers. In some embodiments of the invention, the functionality of network 100 described herein may be divided differently among the modules of FIG. 1. In some embodiments of the invention, the functionality of network 100 described herein may be divided into fewer, more and/or different modules than shown in FIG. 1 and/or network 100 may include additional or less functionality than described herein. For example in one of these embodiments, the functionality of SIP server 120 and registrar 160 may be performed by a single device. In another example, in one of these embodiments the functionality of database 140 may be included in registrar 160 and/or SIP server 120. In another example, the functionality of media relay 130, SIP server 120 (and possibly registrar 160 and/or database 140) may be performed by a single device. In another example, the functionality of endpoint A102 and NAT A 152 may be combined in single device and/or the functionality of endpoint B 104 NAT B 154 may be combined in a single device. In some embodiments of the invention, one or more modules shown in FIG. 1 may have more, less and/or different functionality than described herein.

NAT topology for an endpoint includes whether or not the endpoint is hidden by a NAT and if hidden, the type of NAT hiding the endpoint. NAT variations (types) are described for example in RFC 3489. For the convenience of the reader NAT types are informally described below but since these types are known in the art the descriptions below should not be considered binding.

Full Cone: A full cone NAT is one where all requests from the same internal IP address and port are mapped to the same external IP address and port. Furthermore, any external element can send a packet to an internal element (i.e. behind the NAT), by sending a packet to the mapped external address.

Restricted Cone (AKA address restricted Cone): A restricted cone NAT is one where all requests from the same internal IP address and port are mapped to the same external IP address and port. Unlike a full cone NAT, an external element (with IP address X) can send a packet to an internal element only if the internal element had previously sent a packet to IP address X.

Port Restricted Cone: A port restricted cone NAT is like a restricted cone NAT, but the restriction includes port numbers. Specifically, an external element can send a packet, with source IP address N and source port P, to an internal element only if the internal element had previously sent a packet to IP address X and port P.

Symmetric: A symmetric NAT is one where all requests from the same internal IP address and port, to a specific destination IP address and port, are mapped to the same external IP address and port. If the same internal element sends a packet with the same source address and port, but to a different destination, a different mapping is used. Furthermore, only the external element that receives a packet can send a User Datagram Protocol UDP packet back to the internal element.

In some embodiments, the method of routing path optimization between endpoints 102 and 104 includes three phases: 1. discovery by each endpoint of NAT topological status, 2. notification (AKA indication) of NAT topological status, and 3. session setup. These embodiments will now be described

### Phase 1: Discovery of NAT Topological Status (Presence or Absence of NAT, and NAT Type, if any)

In phase 1 each endpoint A 102 and B 104 is configured to determine the NAT topological status thereof (i.e. whether or not hiding between NAT 152 and 154 respectively, and if affirmative the type of NAT). In some embodiments, phase 1 is performed by each endpoint at least when there has been a change in NAT topological status, however phase 1 may be performed more often. For example in one of these embodiments phase 1 may be performed by endpoint 102 (or 104) when NAT 152 (or 154) is newly added, changed, or newly removed. As another example, in one of these embodiments phase 1 is executed additionally or alternatively by an endpoint whenever the endpoint has a power source attached or reattached. As another example, in one of these embodiments, phase 1 may additionally or alternatively be performed periodically.

In some embodiments, each endpoint 102 or 104 queries one or more STUN servers (for example pair of STUN servers 110 and 112) to discover the associated NAT topological status thereof. Depending on the embodiment, each endpoint 102 or 104 may use the same or different STUN server(s) than the other uses.

For example, in one of these embodiments described in RFC 3489, one or more STUN binding requests may be used to detect the presence of one or more NATs between endpoint 102 (or 104) and a STUN server (for example server 110 or 112). In the event of multiple NATs hiding the endpoint, the type that is discovered will be the type of the most restrictive NAT between the endpoint and the STUN server receiving the request from the endpoint. The types of NAT, in order of restrictiveness, from most to least, are symmetric, port restricted cone, restricted cone, and full cone.

In this embodiment described in more detail in RFC 3489, a binding request is sent to a first STUN server (for example server 110 or 112), without any flags set in the CHANGE-REQUEST attribute and without the RESPONSE-ADDRESS attribute. The source address of the request will be the mapped (external) address created by the NAT closest to the STUN server. The STUN server when receiving the binding request, copies the source IP address and port into a STUN binding response which is sent to the source IP address and port of the STUN request, arriving at the transmitting endpoint 102 (or 104). The endpoint can determine whether the endpoint is behind a NAT by comparing the IP address and port in the MAPPED-ADDRESS attribute of the received packet with the local IP address and port, and if these addresses/ports match, no NAT is present. If the addresses/ports do not match, at least one NAT is present and in order to determine the type of (the most restrictive) NAT hiding the endpoint, the endpoint 102 (or 104) sends additional binding request(s). For example, endpoint 102 (or 104) could send a second binding request to a different IP address (for example of a second STUN server 112 or 110) but from the same source IP address and port. If the IP address and port in the MAPPED-ADDRESS attribute of the response are different from those in the first response, endpoint 102 (or 104) realizes that the NAT is symmetric. To determine whether behind a full-cone NAT, endpoint 102 (or 104) can send a STUN binding request with both the “change IP” and “change port” flags from the CHANGE-REQUEST attribute set, thereby telling the STUN, server (for example STUN server 10 or 112) to send a response from a different IP address and port (for example of STUN server 112 or 110) than the request was received on. If a response is received, then endpoint 102 (or 104) realizes the NAT is full cone. STUN also allows the endpoint 102 (or 104) to ask the STUN server (for example STUN server 110 or 112) to send the binding response from the same IP address the request was received on but from a different port (i.e. with only the “change port” flag set), allowing endpoint 102 (or 104) to determine whether the NAT is a port restricted cone NAT or an (address) restricted cone NAT. If a response is received, then endpoint 102 (or 104) realizes the NAT is (address) restricted but if no response is received then the NAT is port restricted. The reader will understand that in other embodiments another sequence of binding requests and/or different binding requests may be used to discover the NAT topology of the endpoint and the invention is not bound by any particular sequence or content of binding requests.

In other embodiments, endpoint 102 and/or 104 may become aware of NAT topology without the usage of STUN.

### Phase 2: Notification of NAT Topology

In phase 2, each endpoint 102 or 104 is configured to provide notification (indication) of NAT topological status thereof (as determined in phase 1). In one embodiment, endpoint 102 and/or or 104 may provide notification more than once and the NAT topological status as per the last notification prior to a particular session setup (phase 3) is used by SIP server 120 to determine that particular session setup (i.e. in this embodiment the session setup ignores any previous notifications from the same endpoint).

The notification can be performed in any appropriate manner and is therefore not limited by the invention. For example, in various embodiments endpoint A 102 and B 104 may provide notification using any of the following inter alia: SIP Register message, SIP Invite message (for example inviting SIP server 120), SIP options message, any other SIP message, or any proprietary protocol.

In some embodiments, an endpoint (for example endpoint A 102 and/or B 104) provides notification by amending a standard Register message sent to registrar 160 so as to include an indication of NAT topology. For example, in one of these embodiments the endpoint may send the amended Register message to the IP address of SIP server 120 which will relay the Register message to registrar 160. In accordance with RFC 3261 for SIP, registration creates bindings in a location service for a particular domain that associates an address of record Uniform Resource Identifier URI with one or more contact addresses. The piggy-backing of an indication of NAT topological status to the Register message is an advantage of these embodiments of the invention. Registrar 160 when receiving the Register message, stores the NAT topological information in database 140 in a form understandable by SIP server 120. Depending on the embodiment, the form may be similar or different to the form of indication in the Register message.

In one embodiment, an SIP message other than a Register message, for example an Invite message, options message and/or or any other SIP message, may additionally or alternatively be modified by an endpoint (for example endpoint 102 or 104) to include NAT topological information and may be sent to SIP server 120. The piggy-backing of an indication of NAT topological status to the SIP message is an advantage of this embodiment of the invention. SIP server 120 may store the NAT topological information in database 140 in a form similar or different to the form of indication in the SIP message as long as the form is understandable to the SIP server 120.

In some embodiments, the indication of NAT topological status may be provided in a new (“NAT”) tag, which can be for example concatenated to the contact header and/or any other header of a Register message and/or other SIP message.

An example of an SIP Register message including the NAT tag is presented here with the NAT tag bolded:
REGISTER sip:213.137.73.140 SIP/2.0
Via: SIP/2.0/UDP 192.168.1.100:6060
From: <sip:97226491434@213.137.73.140:6060>
To: <sip:97226491434@213.137.73.140:23768>
Call-ID: a9b7ba70783b617e9998dc4dd82eb3c5@192.168.1.100
CSeq: 1 REGISTER
Contact:
<sip:97226491434@192.168.1.100:23768;user=phone;transport=udp>;action=proxy;nat=1;expires=300
user-agent: D3-SIPPhone-v6.1
Content-Length: 0

In some embodiments, the type of NAT is encoded as a digit in the NAT tag (as shown in the exemplary SIP Register message above). Assuming four possible types of NATs, i.e. symmetric, port-restricted, address-restricted, and full cone, in some embodiments one of four possible digits (for example 1, 2, 3, and 4) could be used by an endpoint to encode in the tag the type of NAT hiding the endpoint. In one of these embodiments, a fifth digit could be used in the tag to instead indicate the absence of a NAT. In another of these embodiments, the tag may be omitted from the Register message (and/or from the other SIP message) if no NAT is present (i.e. the omission or the tag would be an indication that no NAT is present). In another of these embodiments, the NAT tag (or other indication in the Register message and/or other SIP message) may tale any form understandable by registrar 160 and/or SIP server 120.

In another embodiment, the NAT tag or other indication in a form understandable by registrar 150 and/or SIP server 120 may be used in a proprietary protocol.

As long as endpoints 102 and 104 provide notification of NAT topological status so that SIP server 120 can properly set up session (phase 3), embodiments may vary regarding method, means or frequency of notification.

In one embodiment, notification of NAT topological status (phase 2) occurs as often as phase 1 occurs. In another embodiment, notification of NAT topological status occurs additionally or alternatively when an endpoint becomes aware of a change in NAT topological status. In other embodiments, notification of NAT topological status (phase 2) occurs additionally or alternatively more frequently.

For example, in some embodiments phase two is a frequent or continuous process in which each endpoint frequently or continuously provides NAT topological status. This continuous or frequent update may in some cases occur as a side effect of SIP signaling. As explained in RFC 3581, when an endpoint (acting as a client) sends a request, if the request is sent using UDP, the endpoint must be prepared to receive the response on the same IP address and port used to populate the source IP address and source port of the request. This requirement is known as symmetric signaling. Assume that in some of these embodiments, in order to maintain a continuous binding in a NAT (for example NAT A 152 or B 154) between the local IP address/port of an endpoint (for example endpoint A 102 or B 104) and the mapped public IP address/port and therefore allow inbound signaling, the endpoint is required to Register periodically with the interval between registrations below the NAT binding expiration time. If it is assumed that in one of these embodiments, the NAT topological information is included in any Register message sent by the endpoint then NAT topological information will necessarily be sent periodically. Assume that in other of these embodiments, in order to maintain a continuous binding in a NAT (for example NAT 152 or 154) between the local IP address/port of the endpoint (for example endpoint 102 or 104) and the mapped public IP address/port and therefore allow inbound signaling, the endpoint is required to periodically send an options message (and/or the other type(s) of SIP messages) with the interval between transmissions below the NAT binding expiration time. If it is assumed that in one of these other embodiments NAT topological information is included in any options message (and/or other type(s) of SIP messages) sent by the endpoint, then NAT topological information will necessarily be sent periodically.

In one embodiment of the invention, when a Register message is received by registrar 160, the contact address stored in database 140 is based on the transport address/port rather than the local address/port included in the message SDP. More information on maintaining continuous bindings, symmetrical signaling, and storage of the contact address is included in Best Practices for SIP NAT Traversal, www.ag-projects.com/docs/PressArticles/NATtraversal-BestPractices.pdf which is hereby incorporated by reference herein.

### Phase 3—Session Setup

Phase 3 Comprises One or More of the Following Tasks:

a. Attempt to Determine NAT Binding for Initiator Endpoint.

In some embodiments the initiator endpoint (assumed to be endpoint A 102) sends a binding request to STUN server 110 or 112 using as source port the port endpoint A 102 intends to use for the outgoing media stream in the session. In these embodiments, as explained in RFC 3489 the response to such a binding request contains a mapped-address attribute; which provides the public address and port number on NAT 152 as detected by STUN server 110 or 112. (In one of these embodiments where NAT 152 includes a series of NATs, the mapped-address attribute will include the public address and port number of the outermost NAT, as detected by STUN server 110 or 112). The returned public address and port number will be used in these embodiments in the Invite message's SDP sub-message sent by endpoint A 102 (see next task). It should be noted that in this embodiment if NAT 152 is symmetric, one or both of the public address and port number provided in the STUN response and included in the Invite SDP may be inaccurate (i.e. the attempt to discover the NAT binding may fail) because the binding for a symmetric NAT depends on destination IP address and port number as well as on the internal LP address and port number. In other embodiments, the task of attempting to determine the NAT binding may be omitted if NAT 152 is of one or more predetermined types.

b. Initiator Endpoint Sends an SIP Invite Message

Endpoint A 102 (assumed to be the initiator) sends an SIP Invite message for endpoint B 104 (assumed to be the invited party) to SIP, server 120. In some embodiments, the specifics of the Invite message may differ depending on the NAT topology of endpoint A 102 as illustrated in the sample scenarios given further below. Therefore in these embodiments, endpoint A 102 is configured to vary the Invite message based on NAT topology of endpoint A 102. In one of these embodiments, in some sample scenarios the Invite message may indicate if the IP address and/or port number indicated in the SDP of the Invite message should not be used for media routing, for example if endpoint A 102 knows that the address and/or port number in the SDP may be inaccurate.

### C. Determination of Route for Media Streams

In some embodiments of the invention, when a session is being established the NAT topology of both originator endpoint and invited endpoint are taken into account. Therefore in these embodiments, when SIP server 120 receives the Invite message from endpoint A 102 (the initiator) inviting endpoint B 104, SIP server 120 decides how session media streams should be routed based on the NAT topologies of both endpoint A 102 and endpoint B 104, as previously notified in phase 2. In some of these embodiments, SIP server 120 may be configured to access the NAT topological status of endpoints 102 and 104 stored in database 140 and based on the NAT topological status of both endpoints 102 and 104 decide whether media should be routed directly or via media relay 130. In one of these embodiments, if SIP server 120 determines that media relay 130 is required for the session, media relay 130 is added as a ‘middle-man’ in the session setup.

In one embodiment the decision of how media packets should be routed is solely at the discretion of the SIP proxy. In this embodiment SIP server 120 is aware of the NAT topological status of endpoints A 102 and B 104 and therefore has all of the relevant information to make an optimal routing decision. In another embodiment, the decision on how to route the media packets may be made with the participation of other elements in network 100.

Table 1 below summarizes possible network topology combinations (scenarios) for the two communicating endpoints A 102 and B 104, according to one embodiment of the present invention. In all the scenarios the originator will be referred to as endpoint A 102 and the invited endpoint as endpoint B 104. For each topology combination Table 1 shows whether it is possible to create a direct media path between the two endpoints 102 and 104 or whether media relay 130 is required in this embodiment. The discovery of the possible network topology combinations for the two communicating endpoints 102 and 104 and/or whether a direct media path is or is not consequently allowable for each combination are features of some embodiments of the current invention.

TABLE 1
Network topology combinations

| Scenario | Endpoint A's NAT | Endpoint B's NAT | Media Path |
|---|---|---|---|
| 1 | Symmetric | Symmetric | Relayed |
| 2 | Symmetric | Port-Restricted | Relayed |
| 3 | Symmetric | Address-Restricted | Direct |
| 4 | Symmetric | Full Cone | Direct |
| 5 | Port-Restricted | Symmetric | Relayed |
| 6 | Port-Restricted | Port-Restricted | Direct |
| 7 | Port-Restricted | Address-Restricted | Direct |
| 8 | Port-Restricted | Full Cone | Direct |
| 9 | Address-Restricted | Symmetric | Direct |
| 10 | Address-Restricted | Port-Restricted | Direct |
| 11 | Address-Restricted | Address-Restricted | Direct |
| 12 | Address-Restricted | Full Cone | Direct |
| 13 | Full Cone | Symmetric | Direct |
| 14 | Full Cone | Port-Restricted | Direct |
| 15 | Full Cone | Address-Restricted | Direct |
| 16 | Full Cone | Full Cone | Direct |
| 17 | No NAT | Symmetric | Direct |
| 18 | No NAT | Port-Restricted | Direct |
| 19 | No NAT | Address-Restricted | Direct |
| 20 | No NAT | Full Cone | Direct |
| 21 | No NAT | No NAT | Direct |
| 22 | Symmetric | No NAT | Direct |
| 23 | Port restricted | No NAT | Direct |
| 24 | Address-Restricted | No NAT | Direct |
| 25 | Full Cone | No NAT | Direct |

For example, in one embodiment referring to Table 1, SIP server 120 may decide that if both endpoints A 102 and B 104 are symmetric or one endpoint (A 102 or B104) is symmetric and the other endpoint (B 104 or A 102) is port restricted, then media is relayed. Otherwise in this embodiment SIP server 120 may decide that it is possible to create a direct media path.

The scenarios listed in Table 1 above are detailed further below in a separate section, describing in each case whether a direct media connection is possible or not and also how to set up the session in each case, according to one embodiment.

It is possible that in some embodiments, a different table than Table 1 may be generated with different decisions regarding the media path for one or more network topology combinations, for example due to different characteristics of one or more elements in network 100, and/or due to implementation specifics. For example in one embodiment, scenarios listed in Table 1 and described further below are applicable regardless of whether the network topology combination includes one-to-one NAT(s) and/or many-to-one NAT(s), whereas in another embodiment of this example the scenarios are applicable when the combination includes many-to-one NAT(s) but it is possible that one or more of the scenarios may need to be varied in order to be applicable if NAT A 152 and/or NAT B 154 is/are one-to-one NAT(s).

d. Invited Party Receives Invite Message.

In some embodiments, endpoint B 104 (assumed to be the invited endpoint) receives an Invite message from endpoint A 102 or from media relay 130 via SIP server 120, attempts to determine the NAT binding for endpoint B 104 media streams, and replies with an SIP 180-Ringing message.

In some embodiments, endpoint B 104 sends a binding request to STUN server 110 or 112 using as source port the port endpoint B 104 intends to use for the outgoing media stream in the session. In these embodiments, as explained in RFC 3489, the response to such a binding request contains a mapped-address attribute, which provides the public address and port number on NAT 154, as detected by STUN server 110 or 112. (In one of these embodiments, where NAT 14 includes a series of NATs, the mapped address-attribute will include the public address and port number of the outermost NAT, as detected by STUN server 110 or 112). The returned public address and port number will be used in this embodiment in the 180 ringing message's SDP sub-message sent by endpoint 104. It should be noted that in this embodiment if NAT 154 is symmetric the public address and/or port number provided in the response and included in the 180 ringing message SDP may be inaccurate (i.e. the attempt to discover NAT binding may fail) since for a symmetric NAT the binding depends on destination IP address and port number as well as on internal IP address and port number. In another embodiment, the task of attempting to determine the NAT binding may be omitted if NAT 154 is of one or more predetermined types.

In some embodiments, the specifics of the 180 ringing message may differ depending on the NAT topology of endpoint B 104 as illustrated in the sample scenarios given further below. Therefore in these embodiments, endpoint B 104 is configured to vary the 180 ringing message based on NAT topology of endpoint B 104. In one of these embodiments, in some sample scenarios the 180 ringing message may indicate if the IP address and/or port number indicated in the SDP of the 180 ringing message should not be used for media routing, for example if endpoint B 104 knows that the address and/or port number in the SDP may be inaccurate.

In some embodiments of phase three, endpoint A 102 may indicate in the Invite message not to use the IP address/port number in the SDP and/or endpoint B 104 may indicate in the 180 ringing message not to use the IP address/port number listed in the SDP. The “a=setup:active” attribute in the SDP of a message is described for example in TCP-Based Media Transport in the Session Description Protocol (SDP), RFC 4145, and the “a=direction:active attribute” in the SDP of a message is described for example in the Internet Draft titled Connection-Oriented Media Transport in SDP, both of which are hereby incorporated by reference herein. The setting of either of these attributes in the SDP of a message indicates in common practice that the endpoint which transmitted the message will initiate the outgoing connection. In embodiments of the current invention, an endpoint may instead be configured to set the “a=direction:active” attribute and/or the “a=setup:active” attribute in the SDP of a message to indicate to a remote party that when sending media streams to the endpoint, the remote party should use the (source) transport address and port number of the media stream issuing from the endpoint (i.e. the IP address and port number extracted from the packets) and not the media IP address/pot listed in the SDP. In these embodiments, the remote party is configured to recognize the a=direction:active and/or a=setup:active attribute in the SDP and to send media using the extracted address/port number. In one of these embodiments, if the remote party is an endpoint, the endpoint remote party is configured to determine based on its own NAT topological status whether to initially (despite the set a=direction:active attribute and/or a=setup:active attribute) send media packets to the address/port listed in the SDP of the invite or 180 ringing message in order to create a binding in the NAT hiding the endpoint remote party and then once the first media packet is received use the extracted address/port number to send media packets, or whether to wait for the first media packet to be received, in order to use the extracted address/port number to send media packets. The unconventional usage of the a=direction:active attribute and/or a=setup:active attribute in order to indicate the remote party should use the (source) transport address and port number of the media stream issuing from the endpoint (i.e. the IP address and port number extracted from the packets) and not the media IP address/port listed in the SDP is a feature of some embodiments of the current invention. For simplicity of description it is assumed below that the a=direction:active attribute is used and not the a=setup:active attribute.

In some embodiments of phase 3, endpoints A 102 and B 104 use STUN for the purpose of management of the media addresses and ports (i.e. to discover the NAT binding for addresses and ports used for transmitting media) and not to discover the NAT binding for addresses and ports used to transmit the SIP signaling. In other embodiments, STUN may also used to discover the NAT binding for addresses and ports used to transmit SIP signaling and/or another protocol may be used to manage media addresses and ports.

More details on phase three are provided in the discussion below of sample scenarios.

### Sample Scenarios

More details are now provided on the scenarios of phase three which were listed above in table 1, describing in each case whether a direct media connection is possible or not and also how to set up the media connection in each case.

The scenarios listed in table 1 and described in more detail below are examples of scenarios which are presented to aid the reader in understanding one embodiment of the invention and therefore should not be construed as limiting the scope of the invention.

### Scenario 1: A is Behind Symmetric NAT and B is Behind Symmetric NAT

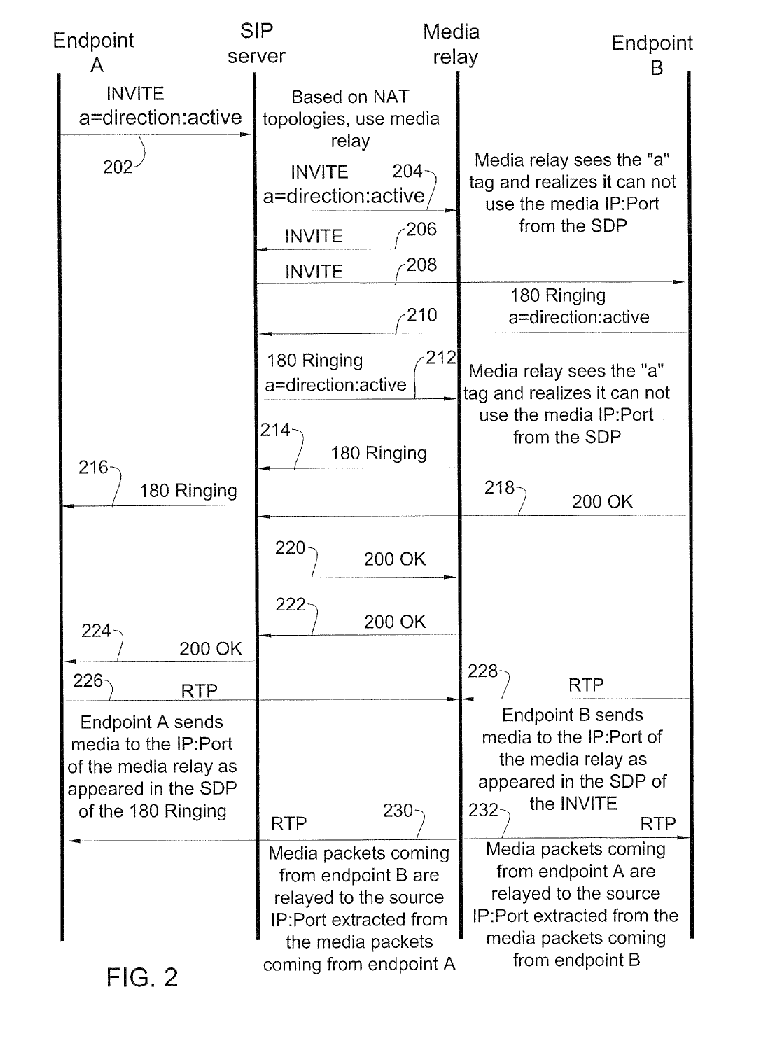

Refer to FIG. 2 which shows a protocol message exchange diagram, according to an embodiment of the present invention.

In stage 202, endpoint A 102 sends an Invite message for endpoint B 104 to SIP server 120. Because NAT A 152 is symmetric, in the SDP endpoint A 102 sets the “a=direction:active” attribute, indicating to a remote party that when sending media streams to endpoint A 102, the (source) transport address and port number of the media stream issuing from endpoint A 102 should be used (i.e. the IP address and port number extracted from the packets should be used) and not the media IP address and port number which are indicated in the SDP from endpoint A 102. Note that in one embodiment, the IP address and port number indicated in the SDP are the address and port number which were included in the mapped-address attribute of a STUN response to a binding request (one or both of which may be incorrect because NAT A 152 is symmetric) whereas in another embodiment, the IP address and port number indicated in the SDP are the private address and port number.

When SIP server 120 receives the Invite message, SIP server 120 retrieves the NAT topological status of both endpoint A 102 (symmetric) and endpoint B 104 (symmetric). Based on the combination, SIP server 120 decides that the media needs to be relayed via media relay 130. Therefore in stage 204 SIP server 120 routes the Invite message to media relay 130. Media relay 130 sees the “a=direction:active” tag and realizes that media relay 130 may not use the media IP address and port number listed in the SDP when transmitting media to endpoint A 102.

In stages 206 and 208, media relay 130 transmits an Invite message to endpoint B 104 via SIP server 120. The SDP of this invite message provides the media address and port number of media relay 130 to which endpoint B 104 needs to send media streams.

In stages 210 and 212, endpoint B 104 sends a 180 Ringing message to media relay 130 via SIP server 120 and because NAT 154 is symmetric, endpoint B 104 sets the attribute “a=direction:active” in the SDP, indicating to a remote party that when sending media streams to endpoint B 104, the (source) transport address and port number of the media stream issuing from endpoint B 104 should be used (i.e. the IP address and port number extracted from the packets should be used) and not the media IP address and port number which are indicated in the SDP from endpoint B 104. Note that in one embodiment, the IP address and port number indicated in the SDP are the address and port number which were included in the mapped-address attribute of a STUN response to a binding request (one or both of which may be incorrect because NAT B 154 is symmetric) whereas in another embodiment, the IP address and port number indicated in the SDP are the private address and port number.

Media relay 130 sees the “a=direction:active” tag and realizes that media relay 130 may not use the media IP address and port number listed in the SDP when transmitting media to endpoint B 104.

In stages 214 and 216, media relay 130 sends a 180 Ringing message to endpoint A 102 via SIP server 120, with the SDP of the 180 Ringing message providing the media address and port number of media relay 130 to which endpoint A 102 needs to send media streams.

In stages 218 and 220, endpoint B 104 transmits a 200 OK message to media relay 130 via SIP server 120. In stages 222 and 224, media relay 130 sends a 200 OK reply message to endpoint A 102 via SIP server 120.

In stage 226, when endpoint A 102 starts sending media packets to the address and port of media relay 130 as appeared in the SDP of the 180 ringing message, media relay 130 may extract from the media packets the media transport address and port number of endpoint A 102. Therefore media relay 130 may send the media coming from endpoint B 104 to the extracted address and port number of endpoint A 102 (stage 230). Similarly, in stage 228 when endpoint B 104 starts sending media packets to the address and port number of media relay 130 as appeared in the SDP of the Invite message, media relay 130 may extract from the media packets the media transport address and port number of endpoint B 104. Therefore media relay 130 may send the media coming from endpoint A 102 to the extracted address and port number of endpoint B 104 (stage 232).

### Scenario 2: A is Behind Symmetric NAT and B is Behind a Port-Restricted NAT

This scenario is similar to scenario 1 with the following changes:

A. In this scenario, when SIP server 120 receives the Invite message, SIP server 120 retrieves the NAT topology of both endpoint A 102 (symmetric) and endpoint B 104 (port restricted) and based on the combination SIP server 120 decides that the media needs to be relayed via media relay 130.

B. In one embodiment of this scenario, endpoint B 104 does not need to set the a=direction attribute in the SDP of the 180 ringing message because endpoint B 104 is behind a port restricted NAT. In this embodiment, media relay 130 may send the media for endpoint B 104 to the address and port number written in the SDP. In another embodiment, endpoint B 104 may set the a=direction attribute and media relay 130 may send the media for endpoint B 104 to the extracted address and port as explained in scenario 1.

Refer to the description above of scenario 1 for more details.

### Scenario 3: A is Behind Symmetric NAT and B is Behind Address Restricted NAT

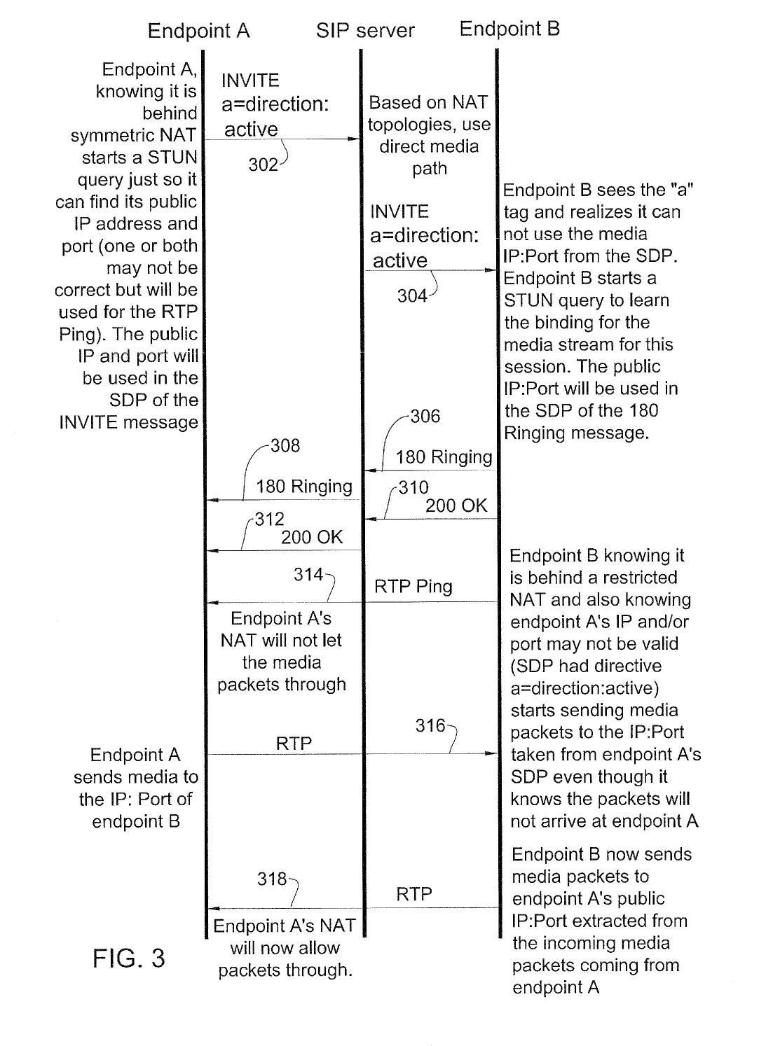

Refer to FIG. 3 which shows a protocol message exchange diagram, according to an embodiment of the present invention.

Endpoint A 102 uses a STUN query to find the NAT-assigned media address and port number, as detected by a STUN server. The address and/or port number included in the mapped-address attribute of a STUN response to a binding request may be incorrect due to NAT 152 being symmetric. However in stage 302 endpoint A 102 lists the media address and port (from the mapped address attribute of the STUNT response) in the SDP of an Invite message for endpoint B 104 sent to SIP server 120. Because NAT 152 is symmetric, in the SDP of the Invite message endpoint A 102 sets the “a=direction:active” attribute which is an indication to the remote party that when sending media streams to endpoint A 102, the (source) transport address and port number of the media stream issuing from endpoint A 102 should be used (i.e. the IP address and port number extracted from the packets should be used) and not the media IP address and port number which are indicated in the SDP from endpoint A 102. However, the IP address and port number advertised in the SDP sent by endpoint A 102 will be used by endpoint B 104 for sending media until the first media packet from endpoint A 102 arrives at endpoint B 104 (see below stage 314).

When SIP server 120 receives the Invite message, SIP server 120 retrieves the NAT topological status of both endpoint A 102 (symmetric) and endpoint B 104 (address restricted) and based on the combination decides that there can be a direct media connection between endpoints A 102 and B 104.

In stage 304, SIP server 120 sends the Invite message to endpoint B 104 (note that the SDP is still set with the “a=direction:active” attribute).

Endpoint B 104 sees the a=direction:active tag in the SDP of the Invite message and realizes that endpoint B 104 should not the use the media IP address and port number advertised in the SDP when transmitting media to endpoint A 102.

Endpoint B 104 uses a STUN query in order to get a public (NAT-assigned) address and port number for the current media stream and puts the public address and port in the SDP of the 180 Ringing message. In stages 306 and 308, the 180 Ringing message is transmitted to endpoint A 102 via SIP server 120.

In stages 310 and 312 endpoint B 104 transmits a 200 OK message to media relay 130 via SIP server 120. In stage 314, because endpoint B 104 is behind an address restricted NAT, endpoint B 104 starts sending media packets to the IP address and port number advertised in the SDP of the Invite message, despite the recognition that the set a=direction:active attribute in the Invite message implies that NAT A 152 will prevent the packets from reaching endpoint A 102. However, the act of sending the media packets from endpoint B 104 to the public address advertised in the SDP of the Invite message from endpoint A 102 will cause a binding in NAT B 154, thereby allowing packets from endpoint A 102 to pass NAT B 154 and reach endpoint B 104. Note that because NAT B 154 is address restricted, endpoint A 102 (with IP address X) can send a packet to endpoint B 104 only if endpoint B 104 had previously sent a packet to IP address X.

In stage 316, endpoint A 102 starts sending media to the media address and port number included in the SDP of the 180 ringing message. The media packets will reach endpoint B 104 because binding already happened (see stage 314).

When endpoint B 104 gets the first media packet from endpoint A 102, endpoint B 104 extracts the (source) transport address and port number of endpoint A 102 from the incoming packet. In stage 318, endpoint B 104 starts sending media packets to the extracted address and port (and not to the address/port advertised in the SDP of the Invite message). These packets will reach endpoint A 102 even though endpoint A 102 is behind a symmetric NAT because of the usage of the extracted address/port.

### Scenario 4: A is Behind Symmetric NAT and B is Behind a Full-Cone NAT

This scenario is similar to scenario 3 with the following changes:

A. When SIP server 120 receives the Invite message, SIP server 120 retrieves the NAT topological status of endpoint A 102 (symmetric) and endpoint B 104 (full cone) and based on the combination decides that there can be a direct media connection between endpoints A 102 and B 104.

B. Endpoint A 102 may or may not perform a STUN query. Therefore, in one embodiment the IP address and port number indicated in the SDP may be the address and port number which were included in the mapped-address attribute of a STUN response to a binding request (one or both of which may be incorrect because NAT A 152 is symmetric) whereas in another embodiment, the IP address and port number indicated in the SDP may be the private address and port number.

C. Because NAT B 154 is full cone, endpoint A 102 can send a packet to endpoint B 104 by sending a packet to the mapped external address associated with endpoint B 104, and therefore stage 314 is optional and may in some cases be omitted. In these cases where stage 314 is omitted, endpoint B 104 instead waits until the first media packet is received from endpoint A 102, extracts the (source) transport address and port number of endpoint A 102 from the incoming packet, and starts sending media packets to the extracted address and port (and not to the address/port advertised in the SDP of the Invite message) in stage 318.

Refer to the description of scenario 3 above for more details.

### Scenario 5: A is Behind Port Restricted NAT and B is Behind Symmetric NAT

This scenario is similar to scenario 1 with the following changes:

A. When SIP server 120 receives the Invite message, SIP server 120 retrieves the NAT topological status of both endpoint A 102 (port restricted) and endpoint B 104 (symmetric) and based on the combination SIP server 120 decides that the media needs to be relayed via media relay 130.

B. In one embodiment of this scenario, endpoint A 102 does not need to set the a=direction attribute in the SDP of the Invite message because endpoint A 102 is behind a port restricted NAT. In this embodiment, media relay 130 may send the media for endpoint A 102 to the address and port written in the SD P. In another embodiment, endpoint A 102 may set the a=direction attribute and media relay 130 may send the media for endpoint A 102 to the extracted address and port as explained in scenario 1.

Refer to the description above of scenario 1 for more details.

### Scenario 6: A is Behind Port Restricted NAT and B is Behind Port Restricted NAT

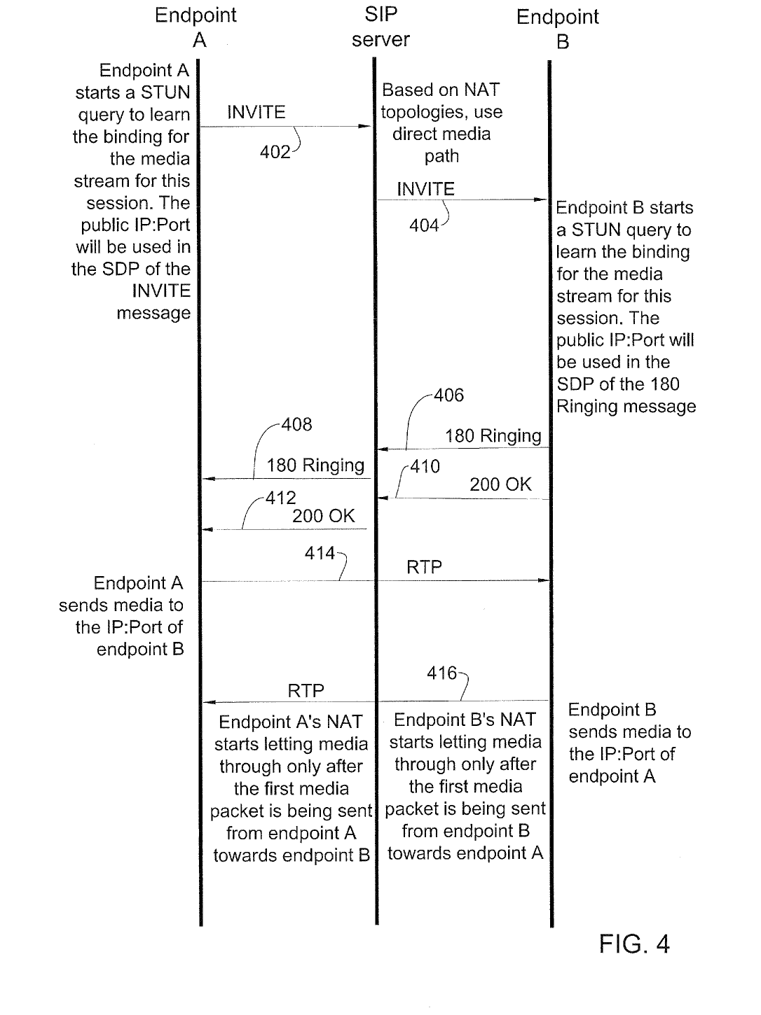

Refer to FIG. 4 which shows a protocol message exchange diagram, according to an embodiment of the present invention.

Endpoint A 102 starts a STUN query to learn the public media address and port number for the session and uses the address and port number in the SDP of an Invite message for endpoint B 104 sent to SIP server 120 in stage 402.

When SIP server 120 receives the Invite message, SIP server 120 retrieves the NAT topological status of both endpoint A 102 (port restricted) and endpoint B 104 (port restricted) and based on the combination decides that there can be a direct media connection between endpoints A 102 and B 104.

Therefore in stage 404, SIP server 120 sends the Invite message to endpoint B 104.

Endpoint B 104 also does a STUN query to learn the public media address and port number for the session and uses the address and port number in the SDP of a 180 ringing message sent in stages 406 and 408 to endpoint A 102 via SIP server 120.

In stages 410 and 412 endpoint B 104 transmits a 200 OK message to media relay 130 via SIP server 120.

In stages 414 and 416, both endpoint A 102 and endpoint B 104 start sending media packets to each other using the address and port advertised in the SDP of 180 Ringing and Invite messages respectively. Because NATs 152 and 154 are port restricted, endpoint A 102 can send a packet, with source JP address X and source port P, to endpoint B 104 only if endpoint B 104 had previously sent a packet to IP address X and port P, and similarly endpoint B 104 can send a packet, with source IP address Y and source port Q, to endpoint A 102 only if endpoint A 102 had previously sent a packet to IP address Y and port Q. The act of endpoint B 104 sending a media packet to endpoint A 102 will cause a binding in NAT B 154 and the act of endpoint A 102 sending a media packet to endpoint B 104 will cause a binding in NAT A 152. Therefore once endpoint B 104 has sent a first media packet to endpoint A 102, media from endpoint A 102 can pass through NAT 154 to endpoint B 104, and once endpoint A 102 has sent a first media packet to endpoint B 104, media from endpoint B 104 can pass through NAT 152 to endpoint A 102.

### Scenario 7: A is Behind Port Restricted NAT and B is Behind Address Restricted NAT

This scenario is similar to scenario 6 with the following changes:

A. When SIP server 120 receives the Invite message, SIP server 120 retrieves the NAT topological status for both endpoint A 102 (port restricted) and endpoint B 104 (address restricted) and based on the combination decides that there call be a direct media connection between endpoints A 102 and B 104.

B. Because NAT B 154 is address restricted, endpoint A 102 (with IP address X) can send a packet to endpoint B 104 only if endpoint B 104 had previously sent a packet to IP address X. Therefore only once endpoint B 104 has sent a first media packet to endpoint A 102, media from endpoint A 102 can pass through NAT 154 to endpoint B 104. Refer to scenario 6 regarding NAT A 152 which is port restricted in both cases.

Refer to description above of scenario 6 for more details.

### Scenario 8: A is Behind Port Restricted NAT and B is Behind Full Cone NAT

This scenario is similar to scenario 7 with the following changes:
A. When SIP server 120 receives the Invite message, SIP server 120 retrieves the type of NAT of both endpoint A 102 (port restricted) and endpoint B 104 (full cone) and based on the combination decides that there can be a direct media connection between endpoints A 102 and B 104.

B. NAT B 154 will allow media from endpoint A 102 to reach endpoint B 104 without waiting for endpoint B 104 to send a first media packet to endpoint A 102 because NAT B 154 is full cone.

See above description of scenario 7 for more details.

### Scenario 9: A is Behind Address Restricted NAT and B is Behind Symmetric NAT

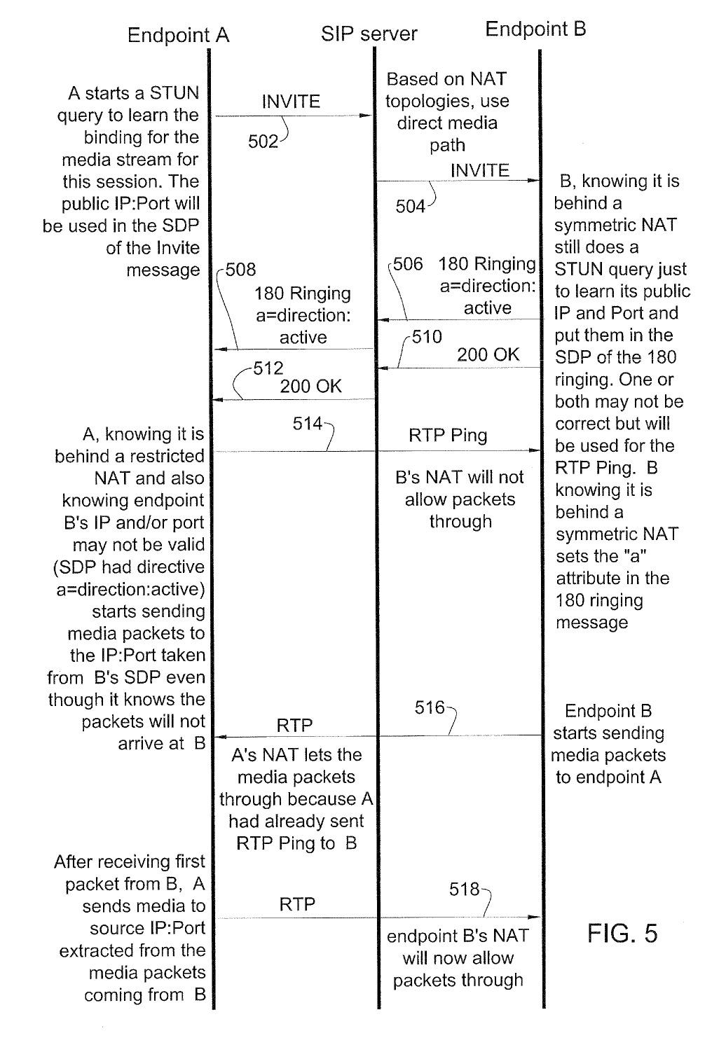

Refer to FIG. 5 which shows a protocol message exchange diagram, according to an embodiment of the present invention.

Endpoint A 102 uses a STUN query to get a public address and port for the current media streams and puts the public address and port in the SDP of an Invite message for endpoint B 104 which endpoint A transmits to SIP server 120 in stage 502.

When SIP server 120 receives the Invite message, SIP server 120 retrieves the NAT topological status of endpoint A 102 (address restricted) and endpoint B 104 (symmetric) and based on the combination decides that there can be a direct media connection between endpoints A 102 and B 104.

In stage 504, SIP server 120 sends the Invite message to endpoint B 104.

Endpoint B 104 uses a STUN query to find the public media address and port number, as detected by the STUN server. The address and/or port number included in the mapped-address attribute of a STUN response to a binding request may be incorrect due to NAT 154 being symmetric. However, endpoint B 104 lists the media address and port (from the mapped address attribute of the STUN response) in the SDP of a 180 ringing message. Because NAT 154 is symmetric, in the SDP of the 180 ringing which is an indication to a remote party that when sending media streams to endpoint B 104, the transport address and port number of the media stream issuing from endpoint B 104 should be used (i.e. the IP address and port number extracted from the packets should be used) and not the media IP address and port number which is indicated in the SDP from endpoint B 104. However, the IP address and port number advertised in the SDP sent by endpoint B 104 will be used by endpoint A 102 for sending media until the first media packet from endpoint B 104 arrives at endpoint A 102 (see below stage 518).

In stages 506 and 508 endpoint B 104 transmits a 180 Ringing message to endpoint. A 102 via SIP server 120. Endpoint A 102 sees the a=direction:active tag in the SDP of the 180 Ringing message and that endpoint A 102 should not the use the media IP address and/or port number advertised in the SDP when transmitting media to endpoint B 104.

In stages 510 and 512 endpoint B 104 transmits a 200 OK message to endpoint A 102 via SIP server 120.

In stage 514, because endpoint A 102 is behind an address restricted NAT, endpoint A 102 starts sending media packets to the IP address and port number advertised in the SDP of the 180 ringing message, despite the recognition that the set a=direction:active attribute in the 180 ringing message implies that NAT B 154 will prevent the packets from reaching endpoint B 104. However, the act of sending the media packets from endpoint A 102 to the address advertised in the SDP of the 180 ringing message from endpoint B 104 will cause a binding in NAT A 152, thereby allowing packets from endpoint B 104 to pass NAT A 152 and reach endpoint A 102. Note that because endpoint A 102 is address restricted, endpoint B 104 (with IP address X) can send to a packet to endpoint A 102 only if endpoint A 102 had previously sent a packet to IP address X.

In stage 516, endpoint B 104 starts sending media to the media address and port number included in the SDP of the Invite message. The media packets will reach endpoint A 102 because binding has already happened (see stage 514).

When endpoint A 102 gets the first media, packet from endpoint B 102, endpoint A 102 extracts the (source) transport address and port number of endpoint B 104 from the incoming packets. In stage 518, endpoint A 102 starts sending media packets to the extracted address and port (and not to the address/port advertised in the SDP of the 180 ringing message). These packets will reach endpoint B 104 even though endpoint B 104 is behind a symmetric NAT because of the usage of the extracted address/port.

### Scenario 10: A is Behind Address Restricted NAT and B is Behind Port Restricted NAT

This scenario is similar to scenario 6 with the following changes:

A. When SIP server 120 receives the Invite message, SIP server 120 retrieves the NAT topological status for both endpoint A 102 (address restricted) and endpoint B 104 (port restricted) and based on the combination decides that there can be a direct media connection between endpoints A 102 and B 104.

B. Because NAT A 152 is address restricted, endpoint B 104 (with IP address X) can send a packet to endpoint A 102 only if endpoint A 102 had previously sent a packet to IP address X. Therefore only once endpoint A 102 has sent a first media packet to endpoint B 104, media from endpoint B 104 can pass through NAT A 152 to endpoint A 102. Refer to scenario 6 regarding NAT B 154 which is port restricted in both cases.

Refer to description above of scenario 6 for more details.

### Scenario 11: A is Behind Address Restricted NAT and B is Behind Address Restricted NAT

This scenario is similar to scenario 6 with the following changes:

A. When SIP server 120 receives the Invite message, SIP server 120 retrieves the NAT topological status for both endpoint A 102 (address restricted) and endpoint B 104 (address restricted) and based on the combination decides that there can be a direct media connection between endpoints A 102 and B 104.

B. Because NATs A 152 and B 154 are address restricted, endpoint A 102 (with IP address X) can send a packet to endpoint B 105 only if endpoint B 104 had previously sent a packet to IP address X and similarly endpoint B 104 (with IP address Y) can send a packet to endpoint A 102 only if endpoint A 102 had previously sent a packet to IP address Y. Therefore once endpoint B 104 has sent a first media packet to endpoint A 102, media from endpoint A 102 can pass through NAT 154 to endpoint B 104, and once endpoint A 102 has sent a first media packet to endpoint B 104, media, from endpoint B 104 can pass through NAT 152 to endpoint A 102.

Refer to description above of scenario 6 for more details.

### Scenario 12: A is Behind Address Restricted NAT and B is Behind a Full Cone NAT

This scenario is similar to scenario 11 with the following change:

A. When SIP server 120 receives the Invite message, SIP server 120 retrieves the NAT topological status for both endpoint A 102 (address restricted) and endpoint B 104 (full cone) and based on the combination decides that there can be a direct media connection between endpoints A 102 and B 104.

B. NAT B 154 will allow media from endpoint A 102 to reach endpoint B 104 without waiting for endpoint B 104 to send a first media packet to endpoint A 102, because NAT B 154 is full cone.

Refer to description of scenario 11 for more details.

### Scenario 13. A is Behind Full Cone NAT and B is Behind Symmetric NAT

This scenario is similar to scenario 9 with the following changes:

A. When SIP server 120 receives the Invite message, SIP server 120 retrieves the NAT topological status for both endpoint A 102 (full cone) and endpoint B 104 (symmetric) and based on the combination decides that there can be a direct media connection between endpoints A 102 and B 104.

B. In this scenario, endpoint B 102 may or may not perform a STUN query. Therefore, in one embodiment the IP address and port number indicated in the SDP may be the address and port number which were included in the mapped-address attribute of a STUN response to a binding request (one or both of which may be incorrect because NAT B 154 is symmetric) whereas in another embodiment, the IP address and port number indicated in the SDP may be the private address and port number.

C. In this scenario because NAT A 152 is full cone, endpoint B 104 can send a packet to endpoint A 102 by sending a packet to the mapped external address, and therefore stage 514 is optional and may in some cases be omitted. In these cases (where stage 514 is omitted) endpoint A 102 instead waits until the first media packet is received from endpoint B 104, extracts the (source) transport address and port number of endpoint B 104 from the incoming packet, and starts sending media packets to the extracted address and port (and not to the address/port advertised in the SDP of the Invite message) in stage 518.

Refer to scenario 9 for more details.

### Scenario 14: A is Behind Full Cone NAT and B is Behind Port Restricted NAT

This scenario is similar to scenario 6 with the following change:

A. When SIP server 120 receives the Invite message, SIP server 120 retrieves the NAT topological status for both endpoint A 102 (full cone) and endpoint B 104 (port restricted) and based on the combination decides that there can be a direct media connection between endpoints A 102 and B 104.

B. NAT A 152 will allow media from endpoint B 104 to reach endpoint A 102 without waiting for endpoint A 102 to send a first media packet to endpoint B 104 because NAT A 152 is full cone.

Refer to scenario 6 for more details.

### Scenario 15: A is Behind Full Cone NAT and B is Behind Address Restricted NAT.

This scenario is similar to scenario 11 with the following changes.

A. When SIP server 120 receives the Invite message, SIP server 120 retrieves the NAT topological status for both endpoint A 102 (full cone) and endpoint B 104 (address restricted) and based on the combination decides that there can be a direct media connection between endpoints A 102 and B 104.

B. NAT A 152 will allow media from endpoint B 104 to reach endpoint A 102 without waiting for endpoint A 102 to send a first media packet to endpoint B 104, because NAT A 152 is full cone.

Refer to scenario 11 for more details.

### Scenario 16—A is Behind Full Cone NAT and B is Behind Full Cone NAT

This scenario is similar to scenario 6 with the following change:

A. When SIP server 120 receives the Invite message, SIP server 120 retrieves the NAT topological status for both endpoint A 102 (full cone) and endpoint B 104 (full cone) and decides based on the combination that there can be a direct media connection between endpoints A 102 and B 104.

B. NAT A 152 will allow media from endpoint B 104 to reach endpoint A 102 without waiting for endpoint A 102 to send a first media packet to endpoint B 104 because NAT A 152 is full cone. Similarly NAT 154 will allow media from endpoint A 102 to reach endpoint B 104 without waiting for endpoint B 104 to send a first media packet to endpoint A 102 because NAT B 154 is full cone.

Refer to scenario 6 for more details.

### Scenario 17. A is Behind no NAT and B is Behind Symmetric NAT

This scenario is similar to scenario 13 with the following change:

A. When SIP server 120 receives the Invite message, SIP server 120 retrieves the NAT topological status for both endpoint A 102 (no NAT) and endpoint B 104 (symmetric) and based on the combination decides that there can be a direct media connection between endpoints A 102 and B 104.

Refer to scenario 13 for more details.

### Scenario 18: A is Behind no NAT and B is Behind Port Restricted NAT

This scenario is similar to scenario 14 with the following change:

A. When SIP server 120 receives the Invite message, SIP server 120 retrieves the NAT topological status for both endpoint A 102 (no NAT) and endpoint B 104 (port restricted) and based on the combination decides that there can be a direct media connection between endpoints A 102 and B 104.

Refer to scenario 14 for more details.

### Scenario 19: A is Behind no NAT and B is Behind Address Restricted NAT.

This scenario is similar to scenario 15 with the following change:

A. When SIP server 120 receives the Invite message, SIP server 120 retrieves the NAT topological status for both endpoint A 102 (no NAT) and endpoint B 104 (address restricted) and based on the combination decides that there can be a direct media connection between endpoints A 102 and B 104.

Refer to scenario 15 for more details.

### Scenario 20—A is Behind no NAT and B is Behind Full Cone NAT

This scenario is similar to scenario 16 with the following change:

A. When SIP server 120 receives the Invite message, SIP server 120 retrieves the NAT topological status for both endpoint A 102 (no NAT) and endpoint B 104 (full cone) and based on the combination decides that there can be a direct media connection between endpoints A 102 and B 104.

Refer to scenario 16 for more details.

### Scenario 21—A is Behind no NAT and B is Behind no NAT

This scenario is similar to scenario 16 with the following change:

A. When SIP server 120 receives the Invite message, SIP server 120 retrieves the NAT topological status for both endpoint A 102 (no NAT) and endpoint B 104 (no NAT) and decides that there can be a direct media connection between endpoints A 102 and B 104.

Refer to scenario 16 for more details.

### Scenario 22: A is Behind Symmetric NAT and B is Behind no NAT

This scenario is similar to scenario 4 with the following changes:

A. When SIP server 120 receives the Invite message, SIP server 120 retrieves the NAT topological status of both endpoint A 102 (symmetric) and endpoint B 104 (no NAT) and based on the combination decides that there can be a direct media connection between endpoints A 102 and B 104.

Refer to scenario 4 for more details.

### Scenario 23: A is Behind Port Restricted NAT and B is Behind no NAT

This scenario is similar to scenario 8 with the following change:

A. When SIP server 120 receives the Invite message, SIP server 120 retrieves the type of NAT of both endpoint A 102 (port restricted) and endpoint B 104 (no NAT) and based on the combination decides that there can be a direct media connection between endpoints A 102 and B 104.

See above description of scenario 8 for more details.

### Scenario 24: A is Behind Address Restricted NAT and B is Behind no NAT

This scenario is similar to scenario 12 with the following change:

A. When SIP server 120 receives the Invite message, SIP server 120 retrieves the NAT topological status for both endpoint A 102 (address restricted) and endpoint B 104 (no NAT) and based on the combination decides that there can be a direct media connection between endpoints A 102 and B 104.

Refer to description of scenario 12 for more details.

### Scenario 25—A is Behind Full Cone NAT and B is Behind no NAT

This scenario is similar to scenario 16 with the following change:

A. When SIP server 120 receives the Invite message, SIP server 120 retrieves the NAT topological status for both endpoint A 102 (full cone) and endpoint B 104 (no NAT) and based on the combination decides that there can be a direct media connection between endpoints A 102 and B 104.

Refer to scenario 16 for more details.

In some embodiments of the invention, there may be any of the following advantages:

1. In some embodiments, SIP server 120 is aware of the NAT topological status of both endpoint A 102 (assumed to be initiator endpoint) and endpoint B 104 (assumed to be invited endpoint) and may therefore make an optimal routing decision. If instead, the initiator endpoint made the routing decision without being aware of the NAT topological status of the invited endpoint, then in some cases the initiator endpoint may assume the worse case NAT topological status of the invited endpoint. For example, if the NAT hiding the initiator endpoint were symmetric, then in some embodiments of the current invention only when the NAT of the invited endpoint is also symmetric or port restricted will the media be relayed via a media relay. However, if the initiator endpoint instead made the routing decision and assumed the worse case NAT topological status of the invited endpoint, then media will always be relayed when the initiator endpoint is symmetric.

2. In some embodiments, SIP server 120 does not have to figure out the NAT topological status of the initiator and invited endpoints during the session setup because the endpoints provide prior notification of NAT topological status. If the NAT topological status were instead figured out during the session setup, media packets may initially be routed via a media relay with the SIP server deciding after the initial relayed routing whether or not the media relay is actually required. This figuring out during the session set up may therefore in some cases result in unnecessary media relaying, and in some cases alternatively or additionally prolong the duration of the session set up.

3. In some embodiments, the routing described saves on resources (for example time, cost) because a media relay is used in only a limited number of scenarios.

Other advantages and features of some embodiments of the invention will be apparent to the reader from the description above.

While the invention has been shown and described with respect to particular embodiments, it is not thus limited. Numerous modifications, changes and improvements within the scope of the invention will now occur to the reader.

1. A method for optimally routing media between Session Initiation Protocol (SIP) endpoints, comprising:
during setup of a session between a first and a second SIP endpoints, retrieving a Network Address Translator (NAT) topology associated with said first SIP endpoint and a NAT topology associated with said second SIP endpoint, wherein an indication of said first associated topology and an indication of said second associated NAT topology had been previously provided by said first and second SIP endpoints respectively; and
if a combination of said NAT topology associated with said first endpoint and said NAT topology associated with said second endpoint corresponds to a direct media path, deciding that media will be directly routed between said first and second SIP endpoints during said session.

2. The method of claim 1, wherein at least one of said indications was provided in an SIP Register message.

3. The method of claim 1, wherein said NAT topology associated with said first endpoint and said NAT topology associated with said second endpoint are each from a group comprising: full cone NAT, address restricted NAT, port restricted NAT, symmetric NAT, and no NAT.

4. The method of claim 1, further comprising:
if said combination corresponds to a relayed media path, deciding that media will be routed between said first and second endpoints via a media relay during said session.

5. The method of claim 1, wherein said combination corresponding to a direct media path includes any a combination which is not included in a group comprising: symmetric NAT associated with each of said first and second SIP endpoints; and symmetric NAT associated with one of said first and second SIP endpoint combined with port restricted NAT associated with the other of said first and second SIP endpoints.

6. The method of claim 1, wherein said plurality of combinations corresponding to a direct media path includes a combination where one of said first and second SIP endpoints is associated with a symmetric NAT and the other of said first and second SIP endpoints is associated with a NAT topology from a group comprising: address restricted NAT, full cone NAT, and no NAT.

7. The method of claim 1, further comprising:
receiving an Invite message from one of said first or second endpoint which invites the other of said first or second endpoint; and
if said combination corresponds to a direct media path, sending said Invite message to said other endpoint;
otherwise, if said combination corresponds to a relayed media path, sending said Invite message to a media relay.

8. A method for allowing optimal routing of media between Session Initiation Protocol (SIP) endpoints, comprising:
an SIP endpoint determining a Network Address Translator (NAT) topology associated with said endpoint; and
said SIP endpoint providing an indication of said NAT topology in order to allow an SIP server during a setup of a subsequent session between said endpoint and another endpoint to decide based on said indicated NAT topology and a NAT topology associated with and indicated by said another endpoint whether to route media between said endpoint and said another endpoint directly or via a media relay.

9. The method of claim 8, wherein said SIP endpoint determines said associated NAT topology by sending at least one Simple Traversal of User Datagram Protocol through NATs (STUN) binding request and evaluating at least one response or non-response to said sent at least one binding request.

10. The method of claim 8, wherein said indication is provided in an SIP message.

11. The method of claim 10, wherein said SIP message is a Register message.

12. The method of claim 10, wherein said indication is concatenated to a header in said message.

13. The method of claim 8, further comprising:
said endpoint sending a STUN binding request via a port intended for outgoing media and receiving a response including a mapped address attribute;
said endpoint inserting an address and port number from said mapped address attribute in a session description protocol (SDP) of a message intended for said another endpoint.

14. The method of claim 13, wherein said message is selected from a group comprising:
Invite message and 180 Ringing message.

15. The method of claim 1, further comprising:
said endpoint providing an indication not to use said address and port number included in said SDP for routing media to said endpoint.

16. The method of claim 15, further comprising:
said SIP server forwarding said message to said another endpoint or to said media relay depending on said NAT topologies of said endpoint and said another endpoint;
said another endpoint or said media relay recognizing said indication not to use said address and port number included in said SDP for routing media to said endpoint but to extract an address and port number for routing media to said endpoint from a media packet received from said endpoint.

17. The method of claim 8, further comprising:
said endpoint receiving a message and recognizing an indication in said message not to use an address and port number included in an SDP of said message for routing media to another endpoint but to extract an address and port number for routing media to said another endpoint from a media packet received from said another endpoint; and
said endpoint determining based on a NAT topology of said endpoint whether or not to initially send media to said address and port number included in said SDP in order to create a NAT binding for said endpoint.

18. The method of claim 8, wherein said NAT topology associated with said endpoint and said NAT topology associated with said another endpoint are each from a group comprising: full cone NAT, address restricted NAT, port restricted NAT, symmetric NAT, and no NAT.

19. A system for optimally routing media between Session Initiation Protocol (SIP) endpoints, comprising:
a database configured to store associations between Network Address Translator (NAT) topologies and SIP endpoints, based on notifications received from associated endpoints; and
an SIP server configured to access stored NAT topologies of endpoints participating in a session and to select, based on said accessed NAT topologies, a direct media path or a relayed media path between said participating endpoints.

20. The system of claim 19, including:
means for receiving notifications from endpoints relating to associated NAT topologies and to save associations between notifying endpoints and notified NAT topologies in said database.

21. The system of claim 20, wherein said means includes a registrar and said notifications are included in Register messages sent by associated endpoints.

22. The system of claim 20, wherein said means includes said SIP server and said notifications are included in SIP messages sent by associated endpoints.

23. An SIP endpoint, comprising:
means for determining a Network Address Translator (NAT) topology associated with said endpoint; and
means for providing an indication of said NAT topology in order to allow an SIP server during a setup of a subsequent session between said endpoint and another endpoint to decide based on said indicated NAT topology and a NAT topology associated with and indicated by said another endpoint whether to route media between said endpoint and said another endpoint directly or via a media relay.

24. The endpoint of claim 23, wherein said means for providing an indication includes means for including an indication of said NAT topology in a transmitted SIP message.

25. The endpoint of claim 23, wherein said means for determining includes means for sending Simple Traversal of User Datagram Protocol through NATs (STUN) binding requests and evaluating responses or non-response to said sent binding requests.

26. A network for optimally routing media between Session Initiation Protocol (SIP) endpoints, comprising:
at least one Simple Traversal of User Datagram Protocol through NAT's (STUN) server;
at least two SIP endpoints, each configured to use said at least one STUN server to discover a NAT topology associated with said endpoint;
a database configured to store NAT topologies discovered by said at least two endpoints; and
an SIP server configured to access stored NAT topologies associated with endpoints participating in a session and to select, based on said accessed NAT topologies, a direct media path or a relayed media path between said participating endpoints.

27. The network of claim 26, further comprising:
a media relay configured to relay media between said participating endpoints, if a relayed media path was selected.

28. The network of claim 27, wherein said SIP server and said media relay are comprised in a session border controller (SBC).

29. The network of claim 26, further comprising:
a registrar configured to receive registrar messages from SIP endpoints indicating said discovered NAT topologies.

30. The network of claim 26, further comprising:
at least one NAT hiding at least one of said endpoints.

31. The network of claim 26, wherein said network includes an Internet telephony service provider network which provides voice over internet protocol (VoIP) services.
